(19) United States
(12) Patent Application Publication
(10) Pub. No.: US 2016/0365036 A1
(43) Pub. Date: Dec. 15, 2016

(54) DISPLAY DEVICE AND BRIGHTNESS ADJUSTING METHOD THEREOF

(71) Applicant: SHENZHEN CHINA STAR OPTOELECTRONICS TECHNOLOGY CO., LTD.,, Shenzhen (CN)

(72) Inventors: Jing XU, Shenzhen, Guangdong (CN); Tai-jiun HWANG, Shenzhen, Guangdong (CN)

(73) Assignee: Shenzhen China Star Optoelectrics Technology Co., Ltd., Shenzhen, Guangdong (CN)

(21) Appl. No.: 14/426,099

(22) PCT Filed: Nov. 21, 2014
(86) PCT No.: PCT/CN2014/091882

§ 371 Date: Mar. 4, 2015

(30) Foreign Application Priority Data
Nov. 18, 2014 (CN) 201410660272.4

(51) Int. Cl. G09G 3/3291; G09G 3/3283

(52) U.S. Cl. CPC G09G 3/3291; G09G 3/3283; G09G 2310/08; G09G 2320/045; G09G 2330/021

(57) ABSTRACT

A display device and a brightness adjusting method thereof are provided. The brightness adjusting method includes: detecting a real-time current value of a display panel at working; generating a corresponding control signal according to the magnitude of the real-time current value; determining a real-time voltage of a corresponding level according to the control signal and outputting the real-time voltage of the corresponding level to drive the display panel to work. The invention can, based on real-time situation of the display panel in use, detect the real-time current and change the real-time voltage for driving the display panel according to the feedback of the real-time current, and therefore can ensure the provision of required real-time voltage for working, avoid the problems of reduced current and decreased brightness at fixed voltage when aging and meanwhile can achieve better energy saving effect when non-aging.

### TECHNICAL FIELD

The invention relates to the field of display technology, and particularly to a display device and a brightness adjusting method of the display device.

### DESCRIPTION OF RELATED ART

A luminous principle of an OLED (organic light-emitting diode) display device is that an ITO (indium tin oxide) transparent electrode and a metal electrode respectively are used as an anode and a cathode of device, under the driving of a fixed voltage, electrons and holes are injected to electrode and hole transport layers respectively from the cathode and the anode, the electrons and the holes then are migrated to a light-emitting layer by the electron and hole transport layers respectively and meet with each other in the light-emitting layer to form excitons and make luminescent molecules to be excited, the latter emit a visible light by radiative relaxation. The emitted light can be observed from the ITO side, and the metal electrode also acts as a reflective layer.

Since the OLED display device uses currents flowing through organic material films to generate light, different organic material films will emit different colors of light. Along with the use of OLED display device, the organic materials of device are aging, the luminous efficiencies become low, and the life of the display device is shortened. Different organic materials may be aging at different rates, resulting in different degrees of color aging, and the white field of the display device would be changed along with the use of the display device. In addition, each pixel may be aging at a rate different from that of other pixels, resulting in uneven display. Accordingly, the OLED display device must have a compensation method to maintain its performance.

In the prior art, in order to solve the problem of display caused by aging, a generally used compensation solution is that: for example, an OLED display device includes: a display panel formed with OLED-based pixels, a data processor for processing an image data from a video source and a compensation data from a compensation unit and outputting compensated image data, a timing controller (TCON) for generating a timing control signal according to the output of the data processor, a driver for driving the display panel according to the timing control signal, a display measurement module for measuring the display uniformity of the display panel, and the compensation unit for generating the compensation data according to the measurement result of the display measurement module and transmitting the compensation data to the data processor.

However, if adopting the conventional aging compensation, since the compensation of an IC of the driver is at least one order, after being converted into a current, a difference of currents corresponding to neighboring two orders is large, which makes it impossible to achieve accurate compensation. In addition, when being used in an unaged OLED display device, the conventional compensation method cannot solve the technical problem of large power consumption.

Therefore, there is an urgent need in the art to provide a new display device, in order to solve the technical problem caused by aging.

### SUMMARY

Accordingly, embodiments of the invention provide a display device and a brightness adjusting method thereof, so as to achieve accurate brightness adjustment and meanwhile solve the technical problems of aging and large power consumption.

In order to solve the technical problem, an embodiment of the invention provides a display device including a display panel. The display device further includes: a detection module configured (i.e., structured and arranged) for detecting a real-time current value of the display device at working; a control module electrically connected with the detection module and configured for generating a corresponding control signal according to the magnitude of the real-time current value; a drive module electrically connected with the control module and the display panel individually and configured for determining a real-time voltage of a corresponding level according to the control signal and outputting the real-time voltage of the corresponding level to drive the display panel to work; and a conversion module arranged between the detection module and the control module and electrically connected with the detection module and the control module individually and further configured for converting an externally inputted image data into a corresponding predetermined level according to the magnitude of the real-time current value. The conversion module concretely is configured for converting an image data of 8 bit color depth into an image data of the predetermined level of 10 bit color depth. The control module concretely is configured for generating the corresponding control signal according to the predetermined level.

An embodiment of the invention further provides a display device including a display panel. The display device further includes: a detection module configured for detecting a real-time current value of the display panel at working; a control module electrically connected with the detection module and configured for generating a corresponding control signal according to the magnitude of the real-time current value; and a drive module electrically connected with the control module and the display panel individually and configured for determining a real-time voltage of a corresponding level according to the control signal and outputting the real-time voltage of the corresponding level to drive the display panel to work.

In an exemplary embodiment, the display device further includes: a conversion module arranged between the detection module and the control module and electrically connected with the detection module and the control module individually and configured for converting an externally inputted image data into a corresponding predetermined level according to the magnitude of the real-time current value. The control module concretely is configured for generating the corresponding control signal according to the predetermined level.

In an exemplary embodiment, the display device further includes: a storage module configured for storing a conversion mode between a plurality of real-time current values and corresponding a plurality of predetermined levels, so as to make the conversion module, after determining the corresponding predetermined level from the storage module according to the magnitude of the real-time current value, to convert the image data using the predetermined level.

In an exemplary embodiment, the plurality of real-time current values at least comprise a power-saving current value and an aging current value, the plurality of predetermined levels at least comprise a power-saving level and an aging level, the power-saving current value is corresponding to the power-saving level when non-aging, and the aging current value is corresponding to the aging level when aging. A real-time voltage corresponding to the power-saving level is smaller than a real-time voltage corresponding to the aging level.

In an exemplary embodiment, the conversion module concretely is configured for converting an image data of 8 bit color depth into an image data of a predetermined level in 10 bit color depth.

In order to solve the above technical problem, an embodiment of the invention further provides a brightness adjusting method of a display device. The brightness adjusting method includes: detecting a real-time current value of a display panel at working; generating a corresponding control signal according to the magnitude of the real-time current value; determining a real-time voltage of a corresponding level according to the control signal and outputting the real-time voltage of the corresponding level to drive the display panel to work.

In an exemplary embodiment, the step of generating a corresponding control signal according to the magnitude of the real-time current value includes: converting an externally inputted image data into a corresponding predetermined level according to the magnitude of the real-time current value; and generating the corresponding control signal according to the predetermined level.

In an exemplary embodiment, the brightness adjusting method further includes: storing a conversion mode between a plurality of real-time current values and corresponding a plurality of predetermined levels, which facilitates to convert the image data using the predetermined level after determining the corresponding predetermined level according to the magnitude of the real-time current value.

In an exemplary embodiment, the plurality of real-time current values at least comprise a power-saving current value and an aging current value, the plurality of predetermined levels at least comprise a power-saving level and an aging level, the power-saving current value is corresponding to the power-saving level when non-aging, and the aging current value is corresponding to the aging level when aging. A real-time voltage corresponding to the power-saving level is smaller than a real-time voltage corresponding to the aging level.

In an exemplary embodiment, the step of converting an externally inputted image data into a corresponding predetermined level according to the magnitude of the real-time current value includes: converting an image data of 8 bit color depth into an image data of a predetermined level of 10 bit color depth.

By way of the above technical solutions, the efficacy of the invention is that: the embodiments of the invention can, based on real-time situation of the display panel in use, detect the real-time current and change the real-time voltage of the display panel according to the feedback of the real-time current, and therefore can ensure the provision of required real-time voltage for working, avoid the problems of reduced current and degraded brightness at fixed voltage when aging, and meanwhile can achieve better energy saving effect when non-aging.

### BRIEF DESCRIPTION OF THE DRAWINGS

In order to more clearly illustrate the technical solutions of various embodiments of the present invention, drawings will be used in the description of embodiments will be given a brief description below. Apparently, the drawings in the following description only are some embodiments of the invention, the ordinary skill in the art can obtain other drawings according to these illustrated drawings without creative effort. In the drawings:

FIG. 1 is a schematic block diagram of an embodiment of a display device of the invention;

FIG. 2A is a working principle diagram of a specific application example of the display device in FIG. 1, illustrating an operating mode when non-aging;

FIG. 2B is a working principle diagram of a specific application example of the display device in FIG. 1, illustrating an operating mode when aging; and

FIG. 3 is a flowchart of an embodiment of a brightness adjusting method of a display device of the invention.

### DETAILED DESCRIPTION OF EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

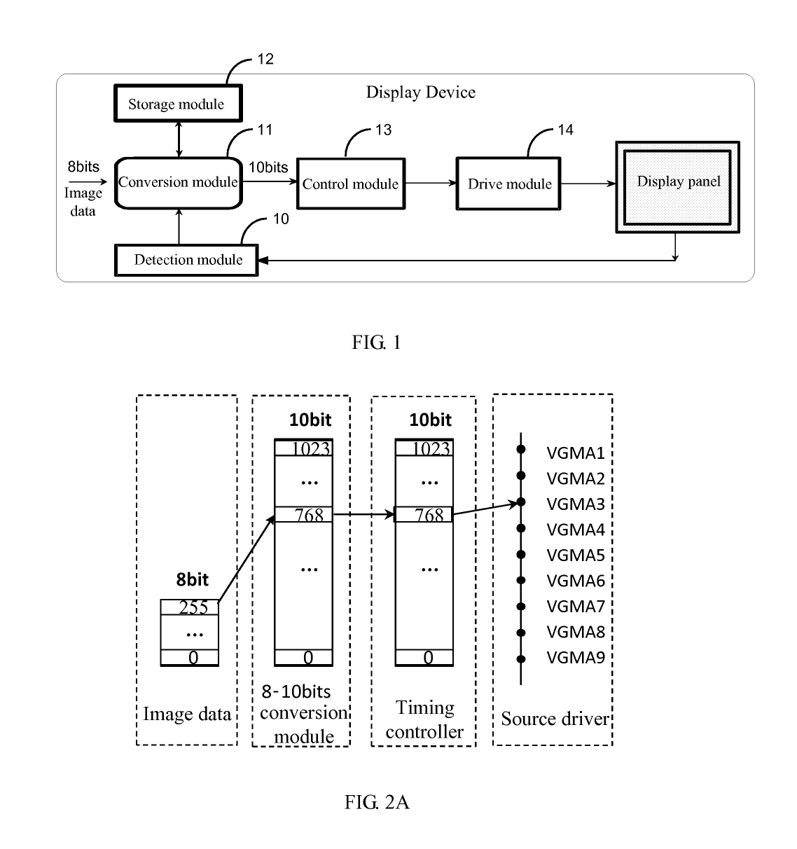

Referring to FIG. 1, FIG. 1 is a schematic block diagram of an embodiment of a display device of the invention. The display device in this embodiment includes but not limited to a display panel (not labeled), a detection module 10, a conversion module 11, a storage module 12, a control module 13 and a drive module 14.

It should be noted that, in this embodiment, the detection module 10 is configured (i.e., structured and arranged) for detecting a real-time current value of the display panel at working. The control module 13 is electrically connected with the detection module 10 and configured for generating a corresponding control signal according to the magnitude of the real-time current value. The drive module 14 is electrically connected with the control module 13 and the display panel individually and configured for determining a real-time voltage of a corresponding level according to the control signal and outputting the real-time voltage of the corresponding level to drive the display panel to work.

In this embodiment, the control module 13 concretely may be a timing controller, the drive module 14 concretely may be a source driver, and the real-time current is a current of OLED display panel.

In a specific implementation process, the conversion module 11 is arranged between the detection module 10 and the control module 13 and electrically connected with the detection module 10 and the control module 13 individually. The conversion module 11 is configured for converting an externally inputted image data into a corresponding predetermined level according to the magnitude of the real-time current value. The control module 13 concretely is configured for generating the corresponding control signal according to the predetermined level. The storage module 12 is configured for storing a conversion mode between multiple (i.e., more than one) real-time current values and corresponding multiple predetermined levels, so that the conversion module 11 can, after determining the corresponding predetermined level from the storage module 12 according to the magnitude of the real-time current value, convert the image data using the predetermined level.

The multiple real-time current values at least include a power-saving current value and an aging current value. The multiple predetermined levels at least include a power-saving level and an aging level. The power-saving current value corresponds to the power-saving level when non-aging, and the aging current value corresponds to the aging level when aging. A real-time voltage corresponding to the power-saving level is smaller than a real-time voltage corresponding to the aging level. It is not difficult to be understood that, when the display panel is non-aging, a brightness thereof is sufficient at rated working voltage and may be excessive, resulting in excessive current and unnecessary energy consumption, and therefore in the actual use of process, the rated working voltage may be reduced to some extent, so as to achieve the effect of energy saving. Conversely, when the display panel is aging, since the resistance is large, the current is relatively smaller at the rated working voltage, the brightness thereof is insufficient, and therefore at this time, the voltage may be raised to make the real-time current reach the magnitude required by the display panel, so as to ensure the user experience.

It should be indicated that, the conversion module 11 concretely is configured for converting an image data of 8-bit color depth into an image data of a predetermined level of 10-bit color depth. In other words, the conversion module 11 preferably is an 8-10bits (i.e., 8bit-to-10bit) convertor. It is not difficult to be understood that, this embodiment uses the conversion module 11 to change the color depth, it may solve the technical problem caused by aging to some extent.

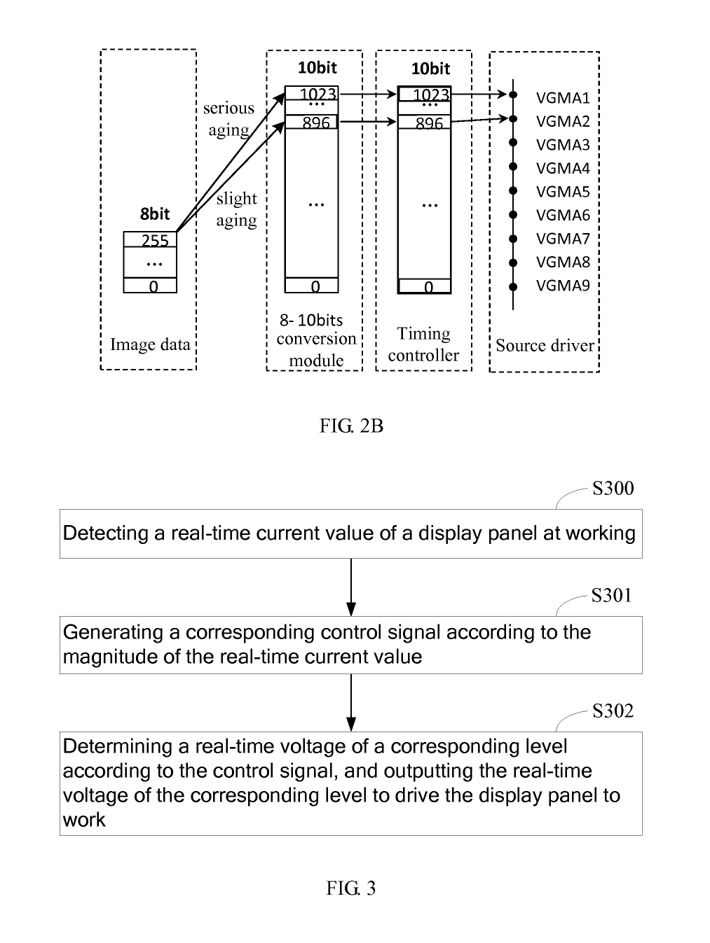

For example, referring to FIGS. 2A and 2B, FIG. 2A is a working principle diagram of a specific application example of the display device in FIG. 1 and illustrates an operating mode of the display device when non-aging, FIG. 2B is a working principle diagram of a specific application example of the display device in FIG. 1 and illustrates an operating mode of the display device when aging.

The conversion module 11 selects a conversion relationship according to feedback aging information of the real-time current and looks up a corresponding value from the storage module 12 to perform 8-10 bits conversion. For example, in a normal situation, 8-bit 255 is converted into 10-bit 768; in a slight aging situation, 8-bit 255 is converted into 10-bit 896; and in a serious aging situation, 8-bit 255 is converted into 10-bit 1023.

Correspondingly, outputted real-time voltages respectively are that: when it is non-aging, 8-bit 255 is converted into 10-bit 768 and the outputted real-time voltage is VGMA3; when it is slight aging, 8-bit 255 is converted into 10-bit 896 and the outputted real-time voltage is VGMA2; and when it is serious aging, 8-bit 255 is converted into 10-bit 1023 and the outputted real-time voltage is VGMA1; and so on. It may be understood that: VGMA1≧VGMA2≧VGMA3≧VGMA4≧VGMA5≧VGMA6≧VGMA7≧VGMA8≧VGMA9.

In summary, the embodiment of the invention can, based on the real-time situation of the display panel in use, detect the real-time current and change the real-time voltage for driving the display panel according to the feedback of the real-time current, and therefore can ensure the provision of required real-time voltage for working, avoid the problems of reduced current and decreased brightness at fixed voltage when aging and meanwhile can achieve better energy saving effect when non-aging.

Referring to FIG. 3, FIG. 3 is a flowchart of an embodiment of a brightness adjusting method of a display device of the invention. In this embodiment, the brightness adjusting method includes but not limited to the following steps S300, S301 and S302.

Step S300: detecting a real-time current value of a display device at working.

Step S301: generating a corresponding control signal according to the magnitude of the real-time current value.

In the step S301, this embodiment concretely may convert an externally inputted image data into a corresponding predetermined level according to the magnitude of the real-time current value and generate the corresponding control signal according to the predetermined level.

It should be noted that, this embodiment may store a conversion mode between multiple real-time current values and corresponding multiple predetermined levels in advance, and after determining the corresponding predetermined level according to the magnitude of the real-time current value, convert the image data using the predetermined level. The setting of the multiple real-time current values can be set based on detection or performance of display panel.

Moreover, the multiple real-time current values at least include a power-saving current value and an aging current value, the multiple predetermined levels at least include a power-saving level and an aging level, the power-saving current value is corresponding to the power-saving level when non-aging, the aging current value is corresponding to the aging level when aging. A real-time voltage corresponding to the power-saving level is smaller than a real-time voltage corresponding to the aging level.

It is not difficult to be understood that, when the display panel is non-aging, a brightness thereof is sufficient at rated working voltage and even may be excessive, resulting in excessive current and unnecessary energy consumption, and therefore in the actual use of process, the rated working voltage may be reduced to some extent, so as to achieve the effect of energy saving. Conversely, when the display panel is aging, since the resistance is large, the current is relatively smaller at the rated working voltage, the brightness thereof is insufficient, and therefore at this time, the voltage may be raised to make the real-time current reach the magnitude required by the display panel, so as to ensure the user experience.

It is indicated that, the conversion module 11 concretely is configured for converting an image data of 8-bit color depth into an image data of a predetermined level of 10-bit color depth. In other words, the conversion module 11 preferably is an 8-10 bits (i.e., 8bit-to-10bit) converter. It is not difficult to be understood that, this embodiment may solve the technical problem caused by aging to some extent by changing the color depth via the conversion module 11.

For example, referring to FIGS. 2A and 2B again, FIG. 2A is a working principle diagram of a specific application example of the display device in FIG. 1 and illustrates an operating mode when non-aging, FIG. 2B is a working principle diagram of a specific application example of the display device in FIG. 1 and illustrates an operating mode when aging.

The conversion module 11 selects a conversion relationship according to feedback aging information of the real-time current and looks up a corresponding value from the storage module 12 to perform an 8-10 bits (i.e., 8bit-to-10bit) conversion. For example, in the normal situation, 8-bit 255 is converted into 10-bit 768; in a slight aging situation, 8-bit 255 is converted into 10-bit 896; and in a serious aging situation, 8-bit 255 is converted into 10-bit 1023.

Correspondingly, outputted real-time voltages respectively are that: when it is non-aging, 8-bit 255 is converted into 10-bit 768 and the outputted real-time voltage is VGMA3; when it is slight aging, 8-bit 255 is converted into 10-bit 896 and the outputted real-time voltage is VGMA2; when it is serious aging, 8-bit 255 is converted into 10-bit 1023 and the outputted real-time voltage is VGMA1; and so on. It may be understood that: VGMA1≧VGMA2≧VGMA3≧VGMA4≧VGMA5≧VGMA6≧VGMA7≧VGMA8≧VGMA9.

Step S302: determining a real-time voltage of a corresponding level according to the control signal and outputting the real-time voltage of the corresponding level to drive the display panel to work.

Sum up, the embodiment of the invention can, based on the real-time situation of the display panel in use, detect the real-time current and change the real-time voltage for driving the display panel according to the feedback of the real-time current, and therefore can ensure the provision of required real-time voltage for working, avoid the problems of reduced current and decreased brightness at fixed voltage when aging, and meanwhile can achieve better energy saving effect when non-aging.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A display device comprising a display panel, the display device further comprising:
a detection module, configured for detecting a real-time current value of the display device at working;
a control module, electrically connected with the detection module and configured for generating a corresponding control signal according to the magnitude of the real-time current value;
a drive module, electrically connected with the control module and the display panel individually and configured for determining a real-time voltage of a corresponding level according to the control signal and outputting the real-time voltage of the corresponding level to drive the display panel to work.
a conversion module, arranged between the detection module and the control module and electrically connected with the detection module and the control module individually and configured for converting an externally inputted image data into a corresponding predetermined level according to the magnitude of the real-time current value, wherein the conversion concretely is configured for converting an image data of 8-bit color depth into an image data of the predetermined level of 10-bit color depth;
wherein the control module concretely is configured for generating the corresponding control signal according to the predetermined level.

2. A display device comprising a display panel, the display device comprising:
a detection module, configured for detecting a real-time current value of the display panel at working;
a control module, electrically connected with the detection module and configured for generating a corresponding control signal according to the magnitude of the real-time current value;
a drive module, electrically connected with the control module and the display panel individually and configured for determining a real-time voltage of a corresponding level according to the control signal and outputting the real-time voltage of the corresponding level to drive the display panel to work.

3. The display device as claimed in claim 2, wherein the display device further comprises:
a conversion module, arranged between the detection module and the control module and electrically connected with the detection module and the control module individually and configured for converting an externally inputted image data into a corresponding predetermined level according to the magnitude of the real-time current value;
wherein the control module concretely is configured for generating the corresponding control signal according to the predetermined level.

4. The display device as claimed in claim 3, wherein the display device further comprises:
a storage module, configured for storing a conversion mode between a plurality of real-time current values and corresponding a plurality of predetermined levels, so as to make the conversion module, after determining the corresponding predetermined level from the storage module according to the magnitude of the real-time current value, to convert the image data using the predetermined level.

5. The display device as claimed in claim 4, wherein the plurality of real-time current values at least comprise a power-saving current value and an aging current value, the plurality of predetermined levels at least comprise a power-saving level and an aging level, the power-saving current value is corresponding to the power-saving level when non-aging, and the aging current value is corresponding to the aging level when aging.

6. The display device as claimed in claim 5, wherein a real-time voltage corresponding to the power-saving level is smaller than a real-time voltage corresponding to the aging level.

7. The display device as claimed in claim 5, wherein the conversion module concretely is configured for converting an image data of 8-bit color depth into an image data of a predetermined level in 10-bit color depth.

8. The display device as claimed in claim 6, wherein the conversion module concretely is configured for converting an image data of 8-bit color depth into an image data of a predetermined level of 10-bit color depth.

9. A brightness adjusting method of a display device, the brightness adjusting method comprising:
detecting a real-time current value of a display panel at working;
generating a corresponding control signal according to the magnitude of the real-time current value;
determining a real-time voltage of a corresponding level according to the control signal and outputting the real-time voltage of the corresponding level to drive the display panel to work.

10. The brightness adjusting method as claimed in claim 9, wherein the step of generating a corresponding control signal according to the magnitude of the real-time current value comprises:
converting an externally inputted image data into a corresponding predetermined level according to the magnitude of the real-time current value;
generating the corresponding control signal according to the predetermined level.

11. The brightness adjusting method as claimed in claim 10, wherein the brightness adjusting method further comprises:
storing a conversion mode between a plurality of real-time current values and corresponding a plurality of predetermined levels, which facilitates to convert the image data using the predetermined level after determining the corresponding predetermined level according to the magnitude of the real-time current value.

12. The brightness adjusting method as claimed in claim 11, wherein the plurality of real-time current values at least comprise a power-saving current value and an aging current value, the plurality of predetermined levels at least comprise a power-saving level and an aging level, the power-saving current value is corresponding to the power-saving level when non-aging, and the aging current value is corresponding to the aging level when aging.

13. The brightness adjusting method as claimed in claim 12, wherein a real-time voltage corresponding to the power-saving level is smaller than a real-time voltage corresponding to the aging level.

14. The brightness adjusting method as claimed in claim 12, wherein the step of converting an externally inputted image data into a corresponding predetermined level according to the magnitude of the real-time current value comprises:
converting an image data of 8-bit color depth into an image data of a predetermined level of 10-bit color depth.

15. The brightness adjusting method as claimed in claim 13, wherein the step of converting an externally inputted image data into a corresponding predetermined level according to the magnitude of the real-time current value comprises:
converting an image data of 8-bit color depth into an image data of a predetermined level of 10-bit color depth.
